(19) United States
(12) Patent Application Publication
(10) Pub. No.: US 2007/0270050 A1
(43) Pub. Date: Nov. 22, 2007

(54) Connecting Terminal

(76) Inventors: Tsugio Anbo, Tokyo (JP); Yukifumi Machida, Tokyo (JP); Claude Casses, Clevilliers (FR)

Correspondence Address: HARRINGTON & SMITH, PC, 4 RESEARCH DRIVE, SHELTON, CT, 06484-6212, US

(21) Appl. No.: 10/561,013

(22) PCT Filed: Jun. 17, 2004
(86) PCT No.: PCT/JP04/08536

§ 371 Date: Feb. 21, 2007

(30) Foreign Application Priority Data
Jun. 18, 2003 (JP) 2003-173928

(51) Int. Cl. H01R 4/10

(52) U.S. Cl. 439/879

(57) ABSTRACT

A connecting terminal has a rectangular tube-like connecting portion including a bottom plate 13, a first side plate 14, a top plate not shown and a second side plate not shown, a movable contact strip 20 is secured to the bottom plate 13 at a base portion 20a, said movable contact strip 13 being further bent into a shape of mountain such that an apex of the mountain constitutes a contact portion 20d. Prior to the formation of the connecting portion, the movable contact strip 13 is folded over the bottom plate 13. An elongated strip portion of the bottom plate 13 is cut and bent inwardly to form a reinforcing strip not shown. A rear end of the movable contact strip is connected to the bottom plate 13 and a free front end of the reinforcing strip is urged against a lower surface of the contact portion 20d of the movable contact strip 20. At a front end of the connecting portion 11, a guide strip 22 is formed by folding back a front end portion of the bottom plate 13 such that the guide strip 22 covers the free front end 20c of the movable contact strip 20 to prevent an upward movement of the free front end 20c and to guide a corresponding male type connecting terminal.

### TECHNICAL FIELD

The present invention relates to a female type connecting terminal to be connected to a male type connecting terminal, said female type and male type connecting terminal constituting an electrical connector.

### TECHNICAL BACKGROUND

It has been practiced to arrange a movable contact strip having an elasticity within a connecting portion of a female type connecting terminal and an inserted male type connecting terminal is clamped resiliently by the movable contact strip. Recently it has been required to provide electrical connectors having a small size and larger number of poles, and therefore connecting terminals arranged within the connectors should be small. For the female type connecting terminal, a contact point of a movable contact strip to be connected to a corresponding male type connecting terminal should be provided at a forward position as far as possible and an insertion force of the male type connecting terminal should be small.

In order to meet the above mentioned requirements there have been proposed the following known connecting terminals.

(1) As shown in FIG. 6, within a connecting portion 1, a movable contact strip 3 and a reinforcing strip 4 are bent upward from a bottom plate 2 and tips of these strips are overlapped with each other at a contact point 5.

(2) As illustrated in FIG. 7, a movable contact strip 3 whose root portion is connected to a top plate 6 is bent such that a free end 7 is face forward within a connecting portion 1.

(3) As depicted in FIG. 8, a root portion of the movable contact strip 3 bent into U-shape is connected to a top plate 6 and a free end 7 of the movable contact strip 3 facing forward is bent toward a bottom plate 2 such that a tip of the free end 7 is engaged with a guide strip 8 provided at a front end of the bottom plate 2.

### DISCLOSURE OF THE INVENTION

Problems to be Solved by the Invention

In the known connecting terminal (1), the front end of the movable contact strip 3 is fixed and a rear end of the movable contact strip is free. Therefore, a rather large force is required for inserting the male type connecting terminal into the female type connecting terminal.

In the known connecting terminal (2), the movable contact strip 3 might be deformed in a flat manner due to a repelling force upon the insertion of the corresponding male type connecting terminal, but it is difficult to provide an elongated reinforcing tab extending from the top plate inwardly.

Furthermore in the known connecting terminal (3), the contact point 5 may be provided near a front end and the terminal inserting force may be reduce, but the movable contact strip 3 extending from the top plate and is bent to cross the connecting portion 1 from up to down. Therefore, during a manufacturing process, an abnormal shape of the connecting terminal could not be checked by projecting a light flux along a longitudinal direction of the connecting portion, because the light flux is interrupted by the movable contact strip.

It is an object of the present invention to provide a connecting terminal which can solve the above mentioned problems of the known connecting terminals and a contact point can be provided near a front end and a force for inserting a male type connecting terminal into the female type connecting terminal can be reduced.

Means for Solving the Problems

In order to attain the above mentioned object, according to the invention, a connecting terminal formed from a single metal plate comprises a rectangular tube-like connecting portion including a bottom plate, a first side plate connected to the bottom plate, a top plate connected to the first side plate, and a second side plate connected to the top plate; a movable contact strip formed by folding a strip-like member which extends in parallel with a side portion of said bottom plate and is coupled with said bottom plate at a rear portion and has a free end, over said bottom plate within the connecting portion, said strip-like member being further bent into a shape of mountain such that an apex of the mountain constitutes a contact point; a reinforcing strip having a rear end connected to said bottom plate and a free end, said reinforcing strip being formed by cutting a portion of the bottom plate and bending the thus cut portion inwardly such that the free end of the reinforcing strip supports the movable contact strip; and a guide strip for guiding a corresponding male type connecting terminal of the electrical connector, said guide strip being formed by folding back a strip-like portion provided at the front end of the bottom plate such that said guide strip covers a front end of the movable contact strip.

Merits of the Invention

In the connecting terminal according to the present invention, the movable contact strip is formed by folding the strip-like member over the bottom plate at the rear portion such that the free end situates at a front side, and the movable contact strip is supported by the reinforcing strip from the underneath, said reinforcing strip being formed by bending the cut portion of the bottom plate upwardly. Therefore, the contact point with the corresponding male type connecting terminal can be positioned near the front end, a force for inserting the male type connecting terminal into the female type connecting terminal can be reduced, and the male type connecting terminal can be clamped with a stable force.

### BRIEF DESCRIPTION OF THE DRAWINGS

FIG. 1 is a perspective view showing an embodiment of the connecting terminal according to the invention.

FIG. 2 is a perspective view illustrating the connecting terminal with a portion being cut out.

FIG. 3 is an enlarged perspective view depicting a portion of the connecting portion a art of which is cut out.

FIG. 4 is a an exploded plan view before assembling.

FIG. 5 is an enlarged perspective view representing a portion of a connecting portion of another embodiment of the connecting terminal according to the invention.

FIG. 6 is a cross sectional view illustrating a known connecting terminal.

FIG. 7 is a cross sectional view showing another known connecting terminal.

FIG. 8 is across sectional view depicting still another known connecting terminal.

### EXPLANATION OF REFERENCE NUMERALS

11 connecting portion
12 wire clamping portion
13 bottom plate
14, 16 side plate
15 top plate
20 movable contact strip
20a base portion
20b rear end
20c free end
20d contact point
20f rib portion
21 reinforcing strip
22 guide strip

### BEST MODE OF THE INVENTION

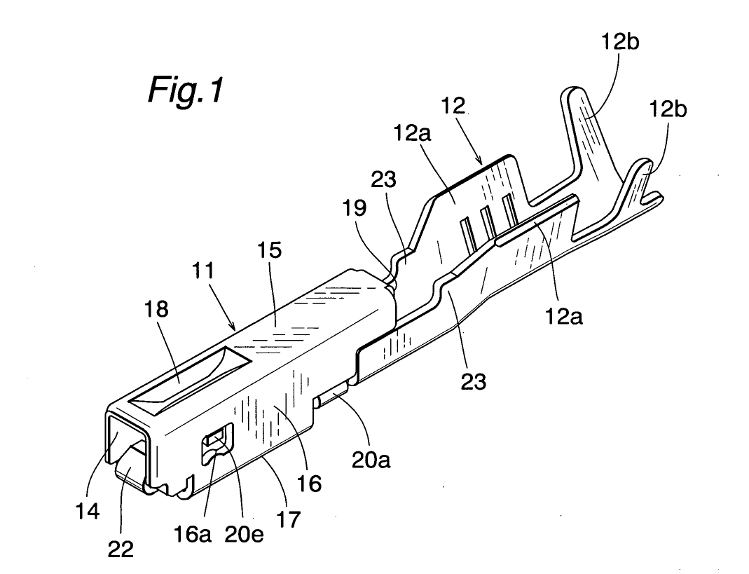

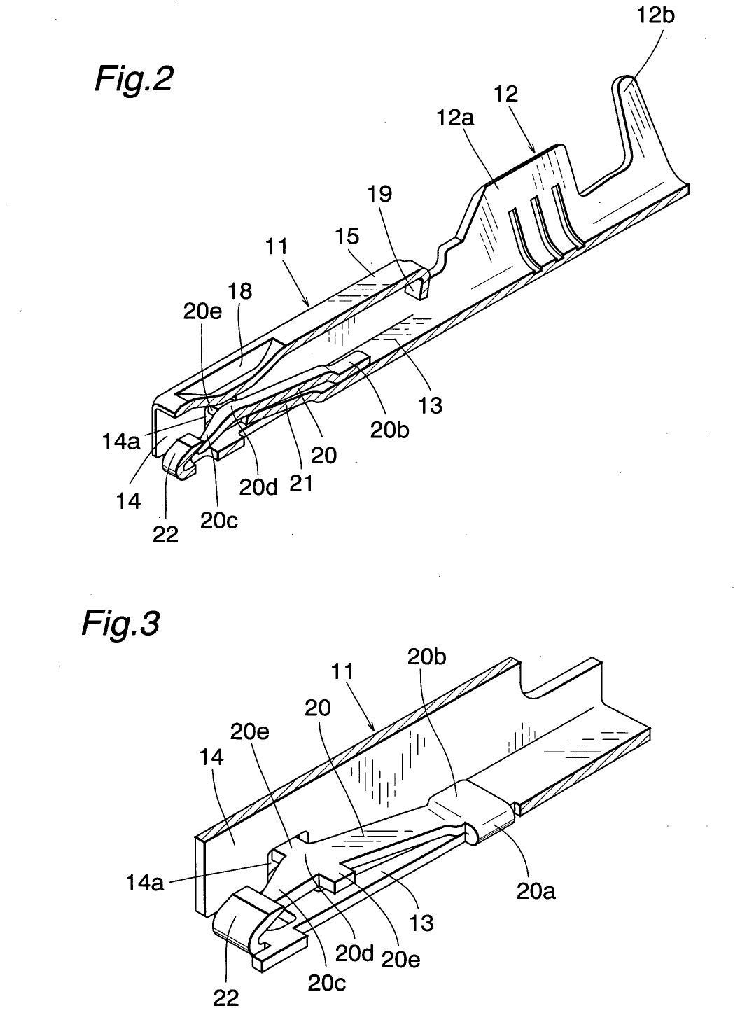

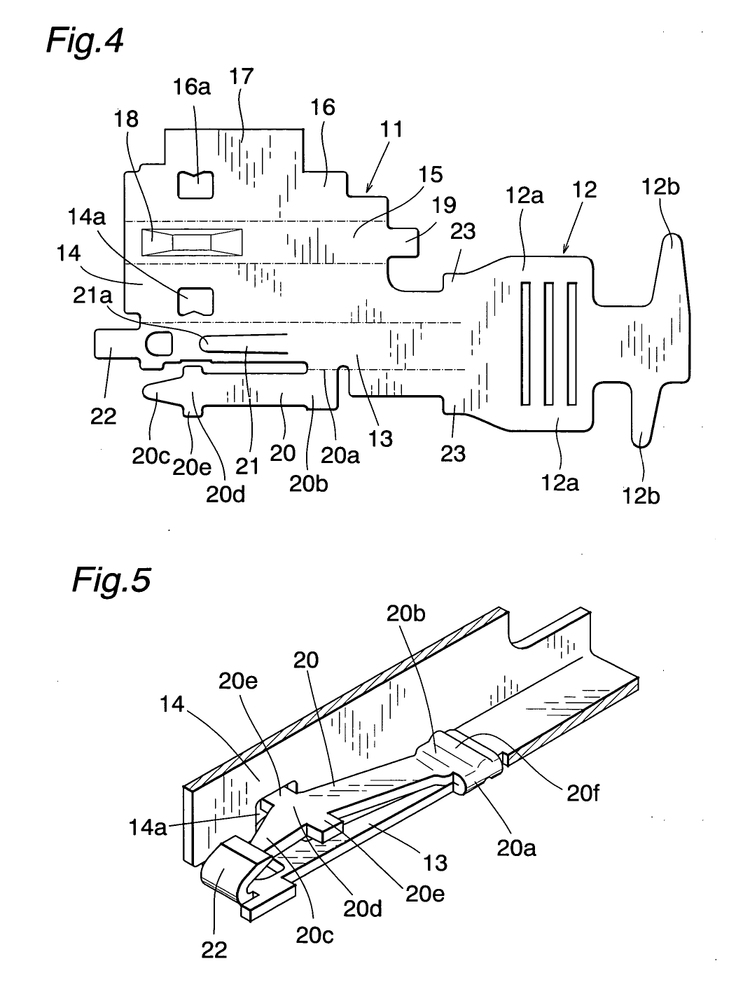

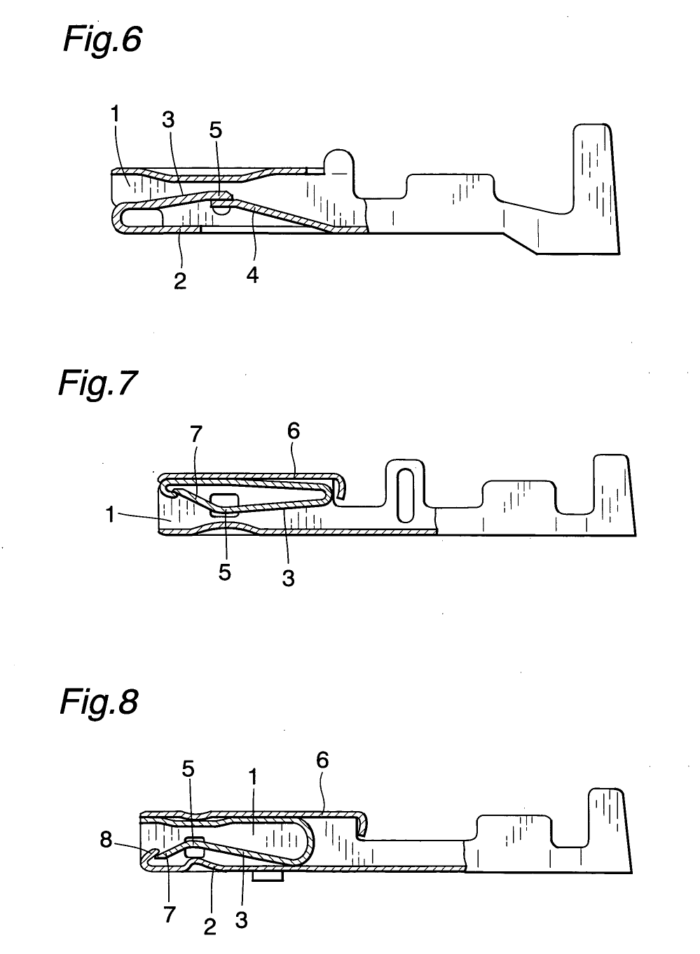

FIG. 1 is a perspective view showing an embodiment of the connecting terminal according to the invention, FIG. 2 is a perspective view illustrating the connecting terminal with a portion thereof being cut out, FIG. 3 is an enlarged perspective view depicting a connecting portion with a portion thereof being cut out, and FIG. 4 is an exploded plan view before folding and bending. The connecting terminal is formed by punching a single metal plate into a given shape, and then folding and bending various portions. Generally speaking, the connecting terminal consists of a rectangular tube-like connecting portion 11 provided at a front side and a wire clamping portion 12 provided at a rear side. As usual, the wire clamping portion 12 includes a core conductor clamping portion 12a and a sheath clamping portion 12b, these clamping portions being formed into a U-shape.

As shown in the exploded plan view of FIG. 4, the connecting portion 11 comprises a bottom plate 13, a first side plate 14 connected to one side of the bottom plate, a top plate 14, a second side plate 16 and a stabilizer portion 17, which are successively coupled with each other in this order. The bottom plate 13, first sided plate 14, top plate 15 and second side plate 16 are folded to constitute a rectangular tube. In the top plate 15 there is formed a recess 18 which extends in a longitudinal direction and is bend inwardly. At a rear end of the top plate 15 there is further formed a locking portion 19, which is bent inwardly to be engaged with a locking lance provided on a housing. The stabilizer portion 17 formed at a side of the second side plate 16 is bent to have a semicircular cross section in such a manner that the stabilizer portion 17 protrudes downward from the bottom plate 13 at a side of the second side plate 16.

On the other side of the bottom plate 13 there is formed a movable contact strip 20 to extend in parallel with the bottom plate 13. The movable contact strip 20 is coupled with the rear portion of the bottom plate 13 at a base portion 20a within the connecting portion 11. Prior to the formation of the connecting portion 11, the movable contact strip 20 is folded at the base portion 20a and is bent in such a manner a portion of the movable contact strip between a rear end 20b and a free front end 20c is bent upward into a shape of mountain. An apex of the mountain situating relatively near to the front end constitutes a contact point 20d for a corresponding male type connecting terminal.

On both sides of the contact point 20d of the movable contact strip 20 there are formed wing portions 20e. These wing portions 20e are inserted movably into holes 14a and 16a formed in the first and second side plates 14 and 16, respectively upon constructing the connecting portion 11.

In the bottom plate 13 there is further formed an elongated reinforcing strip 21 by cutting such that a rear end of the reinforcing strip 21 is connected to the bottom plate 13. The reinforcing strip 21 is folded inwardly such that a front end 21a is brought into contact with a lower surface of the contact portion 20d of the movable contact strip 20.

At the front end of the connecting portion 11, there is provided a guide strip 22, which is formed by folding a front portion of the bottom plate 13 inwardly. The guide strip 22 covers the free front end 20c of the movable contact strip 20 to prevent a forward movement of the free front end and to guide the insertion of the corresponding male type connecting terminal. It should be noted that the connecting portion 11 is formed to maintain the rectangular tube by the stabilizer portion 17 or any other member.

Plate-like portions 23 are provided on both sides of a portion adjacent to a front end of the core conductor clamping portion 12a such that top edges of the plate-like portions 23 are substantially aligned with top edges of the core conductor clamping portion 12a to reinforce the front portion of the core conductor clamping portion 12a.

In the connecting terminal according to the invention having the above explained structure, the contact portion 20d of the movable contact strip 20 can be provided at a relatively front position within the connecting portion 11, and furthermore since the free end of the movable contact strip 20 is constructed by the front end, a resilient force of the movable contact strip is relatively small and a necessary force for inserting the corresponding male type connecting terminal can be reduced.

Moreover, the up and down movement of the free front end 20c of the movable contact strip 20 is limited by the wing portions 20e inserted into the holes 14a and 16a and the upward movement of the free front end 20c is limited by the guide strip 22, and therefore the free front end 20c is effectively prevented from moving up and down largely and the corresponding male type connecting terminal can be inserted easily.

When the corresponding male type connecting terminal is inserted into the connecting portion 11, the movable contact strip 20 is deformed resiliently to become flat, but since the movable contact strip 20 is supported by the reinforcing strip 21, an excessive deformation of the movable contact strip 20 can be effectively avoided, and at the same time, the corresponding male type connecting terminal can be urged against the contact portion 20d with a given pressure.

FIG. 5 depicts another embodiment of the connecting terminal according to the invention. In this embodiment, there are formed ribs 20f in the rear portion 20b of the movable contact strip 20 as well as in the bottom plate 13, said rib extending in a direction perpendicular to the longitudinal direction of the connection portion. By forming such ribs 20f, the rear end 20d of the movable contact strip 20 is fixed to the bottom plate 13 much more firmly. Instead of forming the ribs 20f, the rear end 20b of the movable contact strip may be fused to the bottom plate 13.

What is claimed is:

1. A connecting terminal formed from a single metal plate comprising a rectangular tube-like connecting portion including a bottom plate, a first side plate connected to the bottom plate, a top plate connected to the first side plate, and a second side plate connected to the top plate; a movable contact strip formed by folding a strip-like member which extends in parallel with a side portion of said bottom plate and is coupled with said bottom plate at a rear portion and has a free end, over said bottom plate within the connecting portion, said strip-like member being further bent into a shape of mountain such that an apex of the mountain constitutes a contact portion; a reinforcing strip having a rear end connected to said bottom plate and a free end, said reinforcing strip being formed by cutting a portion of the bottom plate and bending the thus cut portion inwardly such that the free end of the reinforcing strip supports the movable contact strip; and a guide strip for guiding a corresponding male type connecting terminal of the electrical connector, said guide strip being formed by folding back a strip-like portion provided at the front end of the bottom plate such that said guide strip covers a front end of the movable contact strip.

2. The connecting terminal according to claim 1, wherein said free end of the reinforcing strip supports said contact portion of the movable contact strip from underneath.

3. The connecting terminal according to claim 1, wherein ribs are formed in rear portion of the movable contact strip as well as in a corresponding portion of the bottom plate.

4. The connecting terminal according to claim 1, wherein said rear portion of the movable contact strip is fused to the bottom plate.

5. The connecting terminal according to claim 1, wherein said movable contact strip has formed wing portions on both sides, said wing portions being inserted movably into holes formed on the first and second side plates.
